(19) United States
(12) Patent Application Publication
(10) Pub. No.: US 2024/0413920 A1
(43) Pub. Date: Dec. 12, 2024

(54) REMOTE AUDIO ENGINEERING

(71) Applicant: Protostream, LLC, Atlanta, GA (US)

(72) Inventors: Aram David Richard, Atlanta, GA (US); Alexander Wilson Gray, Atlanta, GA (US)

(21) Appl. No.: 18/332,033

(22) Filed: Jun. 9, 2023

(51) Int. Cl. H04H 60/58; H04H 20/18; H04H 60/40

(52) U.S. Cl. CPC H04H 60/58; H04H 20/18; H04H 60/40

(57) ABSTRACT

The present invention is a method for the synchronized, real-time transmission of content data between two geographically separated computing devices. It involves synchronization of timing between devices, receipt of content data at the first device, and real-time transmission to the second device. The second device sends a cue indicating which content data should be included in a broadcast feed and when. Based on this cue, the first device selects the specified content for inclusion at the designated time, and then transmits the broadcast feed to one or more consumers. This method enhances efficiency and synchronization of content transmission between remote devices, allowing real-time adjustments to the broadcast feed.

### FIELD OF DISCLOSURE

The present invention relates generally to content distribution, and more particularly to a method and system for distributing content data, such as audio content, in real-time across geographic locations.

### BACKGROUND

In the field of content distribution, timing synchronization between devices for audio processing is imperative to allow for accurate audio mixing and to synchronize audio and/or video for a broadcast feed. In order to accurately synchronize these feeds, audio engineers are typically required to be present at the venue from which the broadcast originates. It is often necessary for an audio engineer and/or other personnel to travel to an event location to provide support for transmission of a broadcast feed of the event to participating parties. For example, in the field of live entertainment, it may be necessary to provide an audio truck and/or audio booth at the event venue. This necessitates hiring an audio engineer who operates in the vicinity of the event and/or paying for the audio engineer to travel to the event and costs associated therewith (e.g., plane tickets, hotel rooms, meals, etc.). Moreover, this requires rental (or purchase) of a broadcast truck and the specialized broadcast equipment contained therein.

Conventional content distribution techniques have typically relied on the use of specialized hardware and dedicated transmission lines to synchronize content feeds between computing devices. However, these techniques can be expensive, inflexible, and difficult to implement in real-time. Still further, the travel of the audio engineer and the operation of the truck itself can cause carbon or greenhouse gas emissions.

### BRIEF OVERVIEW

This brief overview is provided to introduce a selection of concepts in a simplified form that are further described below in the Detailed Description. This brief overview is not intended to identify key features or essential features of the claimed subject matter. Nor is this brief overview intended to be used to limit the claimed subject matter's scope.

Embodiments of present invention provide a method and system for distributing content data in real-time across geographic locations. The method includes synchronizing timing of a first computing device at a first geographic location and a second computing device at a second geographic location. Content data, comprising a plurality of content feeds, is received at the first computing device and transmitted in real-time to the second computing device. A cue is received from the second computing device, comprising an indication of a subset of the content data and a time at which the subset of the content data is to be included in a broadcast feed. The indicated subset of the content data is selected based on the received cue and included in a broadcast feed at the indicated time. The broadcast feed is transmitted to one or more content consumers.

In some embodiments, the timing of the first and second computing devices is synchronized using Global Positioning System (GPS) receivers that receive GPS communications from GPS satellites. In other embodiments, Network Time Protocol (NTP) or Precision Time Protocol (PTP) is used to synchronize the timing of the computing devices.

In further embodiments, the first computing device is a portable computing device configured for use at a performance venue, and the second computing device is disposed remote from the performance venue. In still further embodiments, the content data included in the broadcast feed remains unchanged until a cue indicating a change to the broadcast feed is received.

Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicant. In addition, the drawings may contain other marks owned by third parties and are being used for illustrative purposes only. All rights to various trademarks and copyrights represented herein, except those belonging to their respective owners, are vested in and the property of the Applicant. The Applicant retains and reserves all rights in its trademarks and copyrights included herein, and grants permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure. In the drawings:

FIG. 1 illustrates a block diagram of a remote audio engineering platform consistent with the present disclosure;

FIG. 2 is a flow chart of a method for providing remote audio engineering;

FIG. 3 is a data flow diagram showing the data flow of communication data through the platform of FIG. 1;

FIG. 4 is a data flow diagram showing the data flow of audio signal data through the platform of FIG. 1; and

FIG. 5 is a block diagram of a system including a computing device for performing the method of FIG. 2.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and are made merely to provide a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such a term to mean based on the contextual use of the term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Regarding applicability of 35 U.S.C. § 112, 16, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subject matter disclosed under the header.

The present disclosure includes many aspects and features. Moreover, while many aspects and features relate to, and are described in, the context of remote audio engineering for a broadcast, embodiments of the present disclosure are not limited to use only in this context.

### I. Platform Overview

This overview is provided to introduce a selection of concepts in a simplified form that are further described below. This overview is not intended to identify key features or essential features of the claimed subject matter. Nor is this overview intended to be used to limit the claimed subject matter's scope.

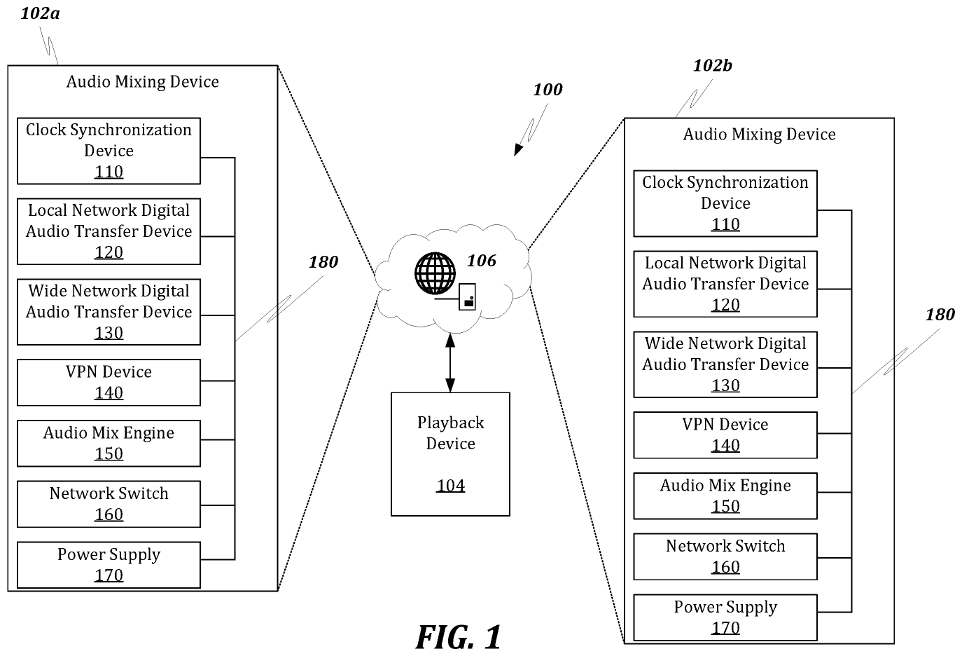

As Shown in FIG. 1, in embodiments, a platform 100 for performing audio engineering (including, but not limited to mixing) for broadcasting an event from a particular location may be provided. The platform 100 may be used to manage and transmit content data, such as audio and/or video feeds, in real time between two computing devices 102a, 102b located in different geographic areas (e.g., a first device at the event venue and a second device located in a geographically different area). The platform 100 may synchronize the timing between the two devices 102a, 102b to help ensure accurate transmission and coordination of content. The first device 102a may receive content data (e.g., one or more video feeds and/or one or more audio feeds) as candidates for inclusion in a broadcast of the event. The first device 102a may transmit the content data in real time to the second device 102b. The second device 102b may further receive a cue from a director indicating a subset of the content data to be included in the broadcast and when to start including the subset Based on the received cue, the second device 102b may cause the first device 102a to select the appropriate content (e.g., the subset indicated by the cue) for inclusion in the broadcast. The platform 100 may further transmit the broadcast feed to viewers or listeners (e.g., from the first device 102a).

In some embodiments, the platform may manage and convert the content data for transmission within local networks and across wide area networks. The platform may further communicate instructions between devices, such as between a studio server and an audio engineer working remotely. In this way, the audio engineer may remotely manage the devices on the network, including, (but not limited to) remotely patching a Dante network, remotely managing various audio devices on the network, and the like.

Embodiments of the present disclosure may comprise methods, systems, and a computer readable medium comprising, but not limited to, at least one of the following:
A. A Clock Synchronization Device;
B. A Local Network Digital Audio Transfer Device;
C. A Wide Network Digital Audio Transfer Device;
D. A Virtual Private Network Device;
E. An Audio Mix Engine;
F. A Network Switch;

In some embodiments, the present disclosure may provide an additional set of modules for further facilitating the software and hardware platform. The additional set of modules may comprise, but not be limited to:
G. A Power Supply; and
H. An Interconnect Cable.

Details with regards to each module are provided below. Although modules are disclosed with specific functionality, it should be understood that functionality may be shared between modules, with some functions split between modules, while other functions duplicated by the modules. Furthermore, the name of each module should not be construed as limiting upon the functionality of the module. Moreover, each component disclosed within each module can be considered independently, without the context of the other components within the same module or different modules. Each component may contain functionality defined in other portions of this specification. Each component disclosed for one module may be mixed with the functionality of other modules. In the present disclosure, each component can be claimed on its own and/or interchangeably with other components of other modules.

The following depicts an example of a method of a plurality of methods that may be performed by at least one of the aforementioned modules, or components thereof. Various hardware components may be used at the various stages of the operations disclosed with reference to each module. For example, although methods may be described to be performed by a single computing device, it should be understood that, in some embodiments, different operations may be performed by different networked elements in operative communication with the computing device. For example, at least one computing device 500 may be employed in the performance of some or all of the stages disclosed with regard to the methods. Similarly, an apparatus may be employed in the performance of some or all of the stages of the methods. As such, the apparatus may comprise at least those architectural components as found in computing device 500.

Furthermore, although the stages of the following example method are disclosed in a particular order, it should be understood that the order is disclosed for illustrative purposes only. Stages may be combined, separated, reordered, and various intermediary stages may exist. Accordingly, it should be understood that the various stages, in various embodiments, may be performed in orders that differ from the ones disclosed below. Moreover, various stages may be added or removed without altering or departing from the fundamental scope of the depicted methods and systems disclosed herein.

Consistent with embodiments of the present disclosure, a method may be performed by at least one of the modules disclosed herein. The method may be embodied as, for example, but not limited to, computer instructions which, when executed, perform the method. The method may comprise the following stages:
synchronizing timing of a first computing device at a first geographic location and a second computing device at a second geographic location;
receiving, at the first computing device, content data, wherein the content data comprises a plurality of content feeds;
transmitting the content data from the first computing device to the second computing device in real time;
receiving, from the second computing device, a cue comprising:
   an indication of a subset of the content data, the subset of the content data indicating one or more content feeds to be included in a broadcast feed, and
   a time at which the broadcast feed is to begin including the subset of the content data;
based on the received cue, selecting the indicated subset of the content data for inclusion in a broadcast feed at the indicated time; and
transmitting the broadcast feed to one or more content consumers.

Although the aforementioned method has been described to be performed by the platform 100, it should be understood that a computing device 500 may be used to perform the various stages of the method. Furthermore, in some embodiments, different operations may be performed by different networked elements in operative communication with computing device 500. For example, a plurality of computing devices may be employed in the performance of some or all of the stages in the aforementioned method. Moreover, a plurality of computing devices may be configured much like a single computing device 500. Similarly, an apparatus may be employed in the performance of some or all stages in the method. The apparatus may also be configured much like computing device 500.

Both the foregoing overview and the following detailed description provide examples and are explanatory only. Accordingly, the foregoing overview and the following detailed description should not be considered to be restrictive. Further, features or variations may be provided in addition to those set forth herein. For example, embodiments may be directed to various feature combinations and sub-combinations described in the detailed description.

### II. Platform Configuration

FIG. 1 illustrates one possible operating environment through which a platform consistent with embodiments of the present disclosure may be provided. By way of non-limiting example, a broadcast platform 100 may include a first computing device 102a and a second computing device 102b. In embodiments, the first computing device 102a may be disposed at a first location corresponding to the event venue (e.g., concert hall, theater, conference room, area, or any other location where an event to be broadcast may be held); the second computing device 102b may be disposed at a second location corresponding to the location of an audio engineer. The first location may be geographically separated from the second location. A user may access platform 100 through a software application and/or hardware device. The software application may be embodied as, for example, but not be limited to, a website, a web application, a desktop application, and a mobile application compatible with the computing device 500. The user may remotely control one or more networked audio devices through the platform 100. For example, a user may access the platform 100 using the second computing device 102b, and may remotely control one or more of the devices embodied in or connected to the first computing device 102a. In embodiments one or more playback devices 104 may receive content from the platform 100 (e.g., via a broadcast feed transmitted from the first device 102a and/or the second device 102b) over a network 106, such as the Internet. The one or more playback devices 104 may receive the mixed audio content, and may be configured to play back the mixed audio content (e.g., as part of a broadcast or livestream, as on-demand content, etc.).

In some embodiments, one or more of the devices 102 of the platform 100 may be contained in a portable housing. The portable housing may have size restrictions governed by portability requirements. For example, the size may be limited to a size based on regulations for carry-on size at an airline. As a particular example, the first device 102a may be contained within a portable case suitable for travel to an event venue. As shown in FIG. @, one or more (e.g., each) of the devices 102a, 102b may include several modules. In some embodiments, each device may include the same modules. In other embodiments, the first device 102a may include a first subset of the modules and the second device 102b may include a second subset of the modules. Accordingly, embodiments of the present disclosure provide a software and hardware platform 100 comprised of a distributed set of computing elements, including, but not limited to:

### A. A Clock Synchronization Device

A clock synchronization device 110 may include hardware and/or software configured to synchronize clock signals across multiple devices 102, such as the first device 102a and the second device 102b.

In some embodiments, the clock synchronization device 110 may include a receiver for receiving time reference signals from a Global Navigation Satellite System (GNSS), such as a Global Positioning System (GPS) satellite. The time reference signal may include for example, a Coordinated Universal Time (UTC) signal, a GPS time signal, a GLONASS Time signal, a Galileo System Time signal, a BeiDou Time signal, and/or any other time signal maintained by the GNSS. For example, GPS time is a continuous time scale (no leap seconds) defined by the GPS Control segment on the basis of a set of atomic clocks at the Monitor Stations and onboard the satellites. GPS time is synchronized with the UTC (USNO) at 1 microsecond level (modulo one second), but may be kept within a tighter tolerance in practice (e.g., 25 ns).

Additionally or alternatively, the clock synchronization device may include hardware and/or software for interfacing with a Network Time Protocol (NTP) server and/or a Precision Time Protocol (PTP) server. NTP can generally regulate time to within tens of milliseconds by connecting all participating devices to one or more time servers. PTP is a protocol used to synchronize clocks with an accuracy in the sub-microsecond range. In embodiments, a PTP server may adhere to standards set forth by Institute for electrical and electronics engineers (IEEE) 1588.

Whether connecting to a GNSS, an NTP server, or a PTP server, the clock synchronization device 110 may be used to synchronize clocks among at least a subset of the deices within the platform 100 such that a time measured at one device (e.g., the first device 102a) is substantially identical to a time measured at another device (e.g., the second device 102b).

In at least some embodiments, a grandmaster clock device, such as the AVN-GMC Grandmaster Clock by Sonifex, may provide at least some of the functionality of the clock synchronization device 110.

### B. A Local Network Digital Audio Transfer Device

A local network digital audio transfer device 120 may include hardware and/or software for transferring audio signals throughout a local network. Digital audio provides several advantages over traditional analog audio distribution. Audio transmitted over analog cables can be adversely affected by signal degradation due to electromagnetic interference, high-frequency attenuation, and voltage drop over long cable runs, whereas digital audio is affected less by these factors. Moreover, digital multiplexing reduces the cabling requirements for digital audio distribution, as compared to analog audio.

The local network digital audio transfer device 120 may receive audio signals from one or more audio input devices, including one or more microphones, one or more instrument pickups, one or more pre-recorded audio sources, and/or any other source of audio input. The local network digital audio transfer device 120 may transfer these signals to one or more other modules of the platform 100 for processing, mixing, and/or other transformation.

In embodiments, the local digital audio transfer device 120 may transfer digital audio signals using a packet switched network (e.g., a local area network). For example, the device 120 may use Dante, a combination of software, hardware, and network protocols, to deliver uncompressed, multi-channel, low-latency digital audio over a standard Ethernet network using Layer 3 IP packets. Dante is used primarily for professional, commercial applications where a large number of audio channels must be transmitted over relatively long distances and/or to multiple locations.

Additionally or alternatively, the local digital audio transfer device 120 may transfer digital audio signals using Multichannel Audio Digital Interface (MADI). MADI is standardized as AES10 by the Audio Engineering Society (AES), which defines the data format and electrical characteristics of an interface that carries multiple channels of digital audio. The MADI standard includes a bit-level description and has features in common with the two-channel AES3 interface. In particular, MADI supports serial digital transmission over coaxial cable or fiber-optic lines of 28, 56, 32, or 64 channels, and sampling rates up to 96 kHz or greater.

In some embodiments, the local digital audio transfer device 120 may be configured to convert audio signals from one format to another. For example, the device 120 may receive one or more audio signals in the MADI format and convert those signals to the Dante format, or receive one or more signals in the Dante format and converting those signals to the MADI format.

In at least some embodiments, a conversion device, such as the EXBOX.MD Dante/MADI Converter by DirectOut, may provide at least some of the functionality of the local digital audio transfer device 120.

### C. A Wide Network Digital Audio Transfer Device

A wide network digital audio transfer device 130 may include hardware and/or software for transferring audio signals throughout a wide area network, such as the Internet. In embodiments, the wide network digital audio transfer device 130 may receive a digital audio signal via a local network (e.g., in a MADI or Dante format) and convert the signal to a format suitable for transmission across the wide area network.

As a particular example, wide network digital audio transfer device 130 may convert the digital audio data to a format for use with Ravenna. Ravenna is a technology for real-time transport of audio and other media data over IP networks. Ravenna can operate on most existing network infrastructures using standard networking technology. Performance and capacity of Ravenna scale with network performance. Ravenna is designed to match broadcasters' requirements for low latency, full signal transparency and high reliability. Ravenna is an IP-based solution, based on protocol levels at or above layer 3 of the OSI reference model. All protocols and mechanisms used within Ravenna are based on widely deployed and established standards. For example, streaming may be based on protocols such as RTP/RTCP, with payload formats defined by various RFCs (e.g., RFC 3550, RFC 3551 etc.); Ravenna is capable of supporting either unicast or multicast communications, on a per-stream basis; Ravenna stream management and connection may be achieved through various protocols, such as SDP and/or RTSP. Ravenna maintains quality of service (QOS) based on a DiffServ mechanism. Other protocols and services may be used with Ravenna.

Additionally or alternatively, the wide network digital audio transfer device 130 may convert the audio signals to other formats and/or make use of other protocols to transfer the audio signals over the wide area network.

In embodiments, the wide network digital audio transfer device 130 may be configured to receive an audio signal via a wide area network, such as the Internet (e.g., using the Ravenna technology). The device 130 may convert audio signals received in this way to a format for use in transfer through the local area network (e.g., MADI and/or Dante format).

In at least some embodiments, a conversion device, such as the EXBOX.RAV Ravenna/MADI Converter by DirectOut, may provide at least some of the functionality of the wide network digital audio transfer device 130.

### D. A Virtual Private Network Device

Each device 102 may include a virtual private network (VPN) device 140. The VPN device 140 may include hardware and/or software configured to create a VPN tunnel for communicating the audio data over the wide area network. The VPN is created by establishing a virtual point-to-point connection through the use of tunneling protocols over existing networks. In some embodiments, the VPN device 140 may be optimized to improve transfer speeds and/or reduce network latency.

In at least some embodiments, a networking device, such as the Vivivaldy audio networking device by Vivivaldy, may provide at least some of the functionality of the VPN device 140.

### E. An Audio Mix Engine

In embodiments, the device 102 may include a mix engine 150. The audio mix engine 150 may include hardware and/or software configured to mix a plurality of input audio signals into a single output audio signal. The mix engine 150 may receive a plurality of audio signals (e.g., from the local network digital audio transfer device 120 and/or the wide network digital audio transfer device 120). The audio mix engine 150 may combine a subset of the received audio signals into a single output audio signal for inclusion in a broadcast feed. In some embodiments, the audio mix engine 150 may normalize a volume of one or more of the received audio signals.

The audio mix engine 150 may allow for a user to combine the signals arbitrarily, in any way the user sees fit. For example, the audio mix engine 150 may include a plurality of volume controls corresponding to the plurality of inputs the mix engine is configured to receive. Each volume may be independently adjustable, such that a user may control a volume of each signal in the output audio feed. In some embodiments, the audio mix engine 150 may be remotely controllable, allowing for a user disposed at a different device 102 on the platform 100 to control the audio mix engine. For example, the audio mix engine 150 may be disposed within the first device 102a, and may be controllable using the second device 102b.

### F. A Network Switch

In embodiments, a network switch 160 may be included in the device 102. The network switch 160 may include hardware and/or software for connecting devices and/or modules on a computer network by using packet switching to receive and forward data to the destination. In some embodiments, the network switch 160 may direct traffic from one device to another device (e.g., from the first device 102a to the second device 102b). Additionally or alternatively, the network switch 160 may direct network traffic between modules within a single device (e.g., from the VPN device 140 to the wide network digital audio transfer device 130). The network switch 160 may manage the flow of data across a network by transmitting a network packet received at the switch to only the one or more devices for which the packet is intended. Each device connected to the switch 160 may be identified by a corresponding network address, allowing the switch to direct the flow of traffic helping to improve or maximize the security and/or efficiency of the network.

In at least some embodiments, a network switch, such as the Netgear 350 by Netgear, may provide at least some of the functionality of the network switch 160.

### G. A Power Supply

In some embodiments, the device 102 may include one or more power supplies 170. The one or more power supplies may include hardware and/or software for connecting the device 102 and various modules contained therein to a main power source (e.g., an electrical main, etc.). In some embodiments, at least one of the one or more power supplies 170 may be configured to convert alternating current power (as provided through a wall outlet) to direct current power for use by the device. In some embodiments, the one or more power supplies 170 may include individual power supplies for each module. In other embodiments, the one or more power supplies 170 may include a single power supply supplying power to each component of the device 102. Using a single power supply may help to reduce size, weight, and/or heat emitted by the one or more power supplies. Using individual power supplies decreases complexity of each individual power supply and allows for easy repairs, should one or more of the individual power supplies fail.

### H. An Interconnect Cable

In some embodiments, an interconnect cable 180 may be used to connect various modules within a device 102. The interconnect cable 180 may be specially designed for interconnection of the module within relatively tight confines of the device 102. In particular, the interconnect cable 180 may reduce space needed for unduly long cabling within the device 102, and may help to reduce the size of one or more cable connectors to reduce a total amount of volume taken up by the cabling within the device 102.

### III. Platform Operation

Embodiments of the present disclosure provide a hardware and software platform operative by a set of methods and computer-readable media comprising instructions configured to operate the aforementioned modules and computing elements in accordance with the methods. The following depicts an example of at least one method of a plurality of methods that may be performed by at least one of the aforementioned modules. Various hardware components may be used at the various stages of operations disclosed with reference to each module.

For example, although methods may be described as being performed by a single computing device, it should be understood that, in some embodiments, different operations may be performed by different networked elements in operative communication with the computing device. For example, at least one computing device 500 may be employed in the performance of some or all of the stages disclosed with regard to the methods. Similarly, an apparatus may be employed in the performance of some or all of the stages of the methods. As such, the apparatus may comprise at least those architectural components found in computing device 500.

Furthermore, although the stages of the following example method are disclosed in a particular order, it should be understood that the order is disclosed for illustrative purposes only. Stages may be combined, separated, reordered, and various intermediary stages may exist. Accordingly, it should be understood that the various stages, in various embodiments, may be performed in arrangements that differ from the ones described below. Moreover, various stages may be added or removed from the without altering or departing from the fundamental scope of the depicted methods and systems disclosed herein.

The method may focus on managing and transmitting content data (e.g., audio data) in real time between two computing devices located at different geographic locations to create a final broadcast feed for the content. To help ensure accurate transmission and coordination of content, the timing between the first computing device at the first geographic location and the second computing device at the second geographic location are synchronized. The first computing device receives content data, which may include multiple video and/or audio feeds. This content data is then transmitted in real time from the first computing device to the second computing device.

The second computing device may send a cue to the first computing device. This cue may contain information about which content feeds should be included in the final broadcast feed and timing information indicating when these content feeds should be integrated into the broadcast. Based on the received cue, the first computing device selects the indicated subset of the content data for inclusion in the broadcast feed at the specified time. Finally, the broadcast feed is transmitted to one or more content consumers, such as viewers or listeners. This method allows for efficient and synchronized transmission of content data between devices located in different places and provides the ability to make real-time adjustments to the final broadcast feed based on received cues.

### A. Method for Engineering Audio Content

Consistent with embodiments of the present disclosure, a method may be performed by at least one of the aforementioned modules. The method may be embodied as, for example, but not limited to, computer instructions, which, when executed, perform the method.

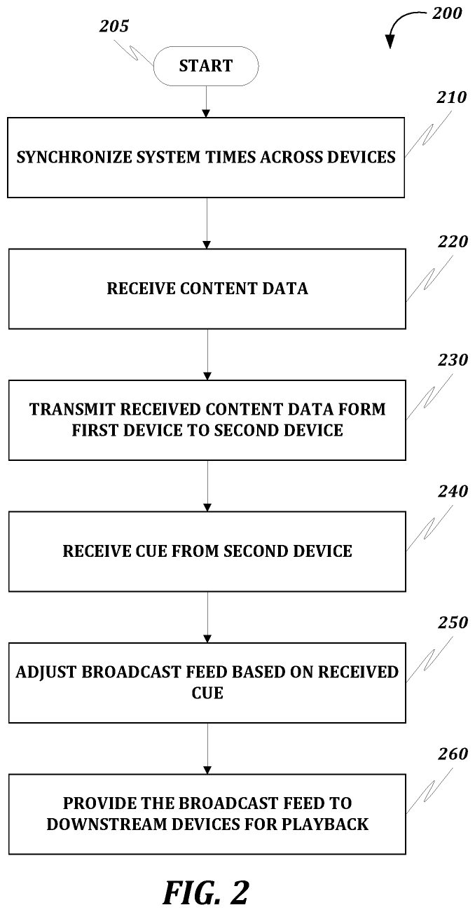

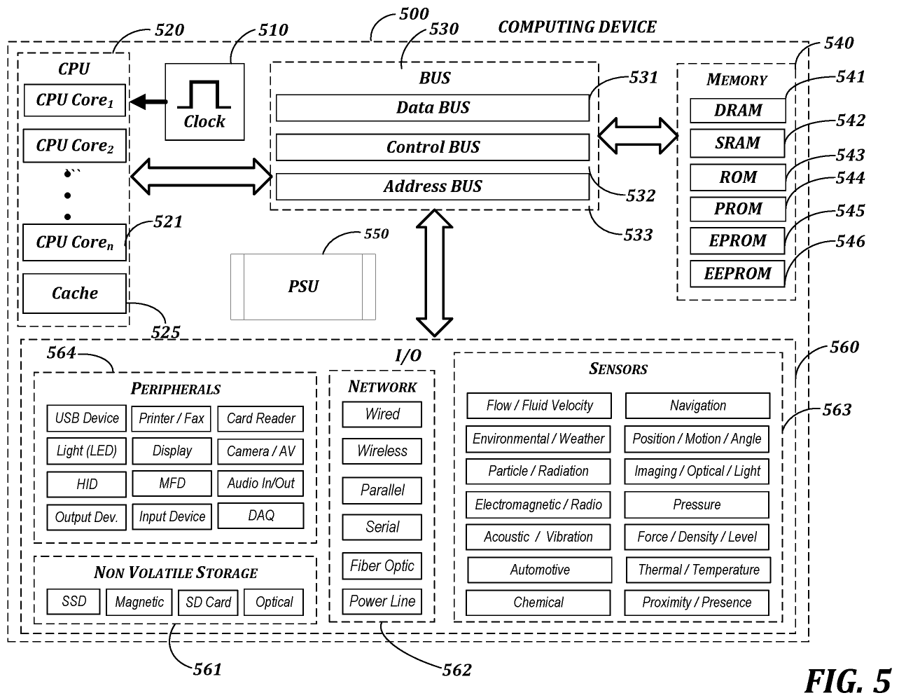

FIG. 2 is a flow chart setting forth the general stages involved in a method 200 consistent with an embodiment of the disclosure for using the remote audio engineering platform 100. Method 200 may be implemented using a computing device 500 or any other component associated with platform 100 as described in more detail below with respect to FIG. 5. For illustrative purposes alone, platform 100 is described as one potential actor in the following stages, however the platform 100 performing the action may be indicative of a device or module within the platform performing the action.

Method 200 may begin at starting block 205 and proceed to stage 210 where the platform 100 may synchronize a system time across multiple devices. For example, the platform may synchronize system time between a first device disposed at a first geographic location associated with an event venue (e.g., a concert hall, arena, meeting room, playhouse, and/or any other location when an event to be broadcast may be held) and a second device disposed at a second geographic location associated with an off-site audio engineer. The first geographic location and second geographic location may be remote from one another, separated by distances on the order of miles, tens of miles, hundreds of miles, or even thousands of miles.

In embodiments, synchronizing the time across devices may comprise causing the device to receive and process a signal comprising a GNSS time (e.g., a GPS time), and setting the system time of each device based on the received GNSS time. Additionally or alternatively, synchronizing the system times may comprise causing the devices to be synchronized to adhere to a time control protocol, such as Network Time Protocol or Precision Time Protocol, such that the devices contact one or more-time servers and set their times based on the responses from one or more of the contacted time servers.

In some embodiments, the synchronization may occur a single time. Alternatively, synchronization may occur periodically or substantially continuously during operation of the platform.

From stage 210, where the platform 100 synchronizes time across multiple devices, method 200 may advance to stage 220 where platform 100 may receive content data, including a plurality of content feeds. The content feeds may be, for example, one or more audio feeds and/or one or more video feeds. In some embodiments, the one or more content feeds may comprise a single type of content (e.g., the one or more content feeds may comprise a plurality of audio feeds. Alternatively, the one or more content feeds may comprise both audio feeds and video feeds.

In embodiments, the one or more content feeds may be received at the first device, disposed at the first geographic location associated with the event venue. The one or more content feeds may include one or more audio feeds, such as live audio feeds (e.g., received from one or more live microphones, instrument pickups, or the like) and/or one or more pre-recorded audio feeds (e.g., received from a playback device). In embodiments, the content feeds may be received in a first audio format for transmission across a local area network. For example, the audio feeds may be received in and/or converted to a format such as Dante. In some embodiments, the content feed may be converted from a first digital format into a second digital format. For example, audio signals may be converted from a Dante format for transmission through a local network to a secondary digital format, such as a MADI format. The secondary digital format may advantageously allow for easier processing and/or may be configured to better allow for conversion to additional formats, as needed.

Once the platform 100 receives the content feeds in stage 220, method 200 may

continue to stage 230 where the platform may transmit the received content data. For example, the platform 100 may transmit the content data from the first device at the first geographic location associated with the event venue to the second device at the second geographic location associated with the audio engineer. Transmission of the received content feeds may take place in real-time or near real time.

In some embodiments, transmission of the received content feeds may require conversion of the content feeds from a first format for use in content transmission through a local area network (e.g., Dante, MADI, etc.) to another format for use in transmission across a wide area network. For example, the content may be converted from MADI format into a format for use with Ravenna technology for transmission of audio data.

In embodiments, the transmission from the first device to the second device may be a secured transmission. For example, the platform may establish a secure tunnel for transfer of information between the first device and the second device (e.g., using a VPN).

In embodiments, the second device may be used to engineer the audio content. As one non-limiting example of audio engineering, the second device may be used to determine a mix of the content feeds that should be provided as at least a portion of an output broadcast feed. For example, the second device may be used to determine the audio portion of the output broadcast feed. Determining the portion of the broadcast feed may include, for example, selecting a subset of the received content feeds for inclusion in the broadcast feed, normalizing a volume of each feed, of the subset of the audio feeds selected for inclusion in the final broadcast feed, and/or making other adjustments to the audio feeds (e.g., adjusting noise gates, low-pass filters, high-pass filters, and/or other settings associated with an audio feed).

In embodiments, the second device may create a cue for transmission to the first device, the cue may include, among other things, an indication the subset of the content feeds determined for inclusion in the final broadcast feed, and a time at which the broadcast feed should be adjusted to include the select subset. In some embodiments, the cue may further comprise an indication of one or more audio properties of the subset of content feeds. The cue may be generated using the audio mix engine to produce an audio mix for the broadcast feed. In some embodiments, the second device may further create a mixed version of the audio output that matched the version for inclusion in the broadcast feed.

In stage 240, the first device may receive the cue from the second device. In some embodiments, the cue may be received via the same method used to transmit the content feeds from the first device to the second device in stage 230. That is, if a VPN is established to transmit the content feeds from the first device to the second device, the VPN may further be used to transmit the cue from the second device to the first device. In other embodiments, the method of transmission of the cue may be independent from the method of transmission of the content feeds.

As discussed above, the cue may include (but is not limited to) an indication of a subset of the content feeds for inclusion in the broadcast feed and a system time at which the broadcast feed is to be adjusted to include the subset of content feeds. In some embodiments, the cue may further include audio data indicating one or more audio features (e.g., volume, gate thresholds, etc.) for one or more (e.g., each) audio feed to be included in the broadcast feed.

In stage 250, responsive to receiving the cue at the first device, the platform 100 may adjust the broadcast feed based on the cue. In particular, the platform 100 may use the first device to adjust the broadcast feed to include the subset of content feeds indicated in the cue. In embodiments, the cue may be used to adjust the content feeds included in the broadcast feed at the time indicated in the cue. For example, if the time indicated in the cue is time t+5 and the system time at which the cue is received is time t, the commands to adjust the broadcast feed may be held without being executed until time t+5 occurs. Then, responsive to the system time t+5 occurring, the commands to adjust the broadcast feed may be executed.

The subset of content feeds indicated by the cue may replace the content feeds currently included in the broadcast feed. For example, if the cue comprises a list of one or more audio feeds to be included in the broadcast feed, the audio feeds included in the cue may replace all audio feeds currently included in the broadcast feed.

In some embodiments, the first device may adjust one or more settings of a mix engine based on the received cue. That is, the mix engine may be set based on the cue, and the setting may remain in place until a new cue is received. The setting of the mix engine may affect the change in content feeds included in the mix engine and/or the audio properties of those content feeds. This advantageously allows for the current settings to remain in effect should a connection between the first device and the second device be lost.

In stage 260, the platform 100 provides the broadcast feed to one or more downstream devices for playback. The broadcast feed may be provided in real-time from the platform 100. Additionally or alternatively, the broadcast feed may be recorded for later playback.

### B. Method for Sending Communications Data Between Devices

Consistent with embodiments of the present disclosure, a method for sending communication data between devices may be performed by at least one of the aforementioned modules. The method may be embodied as, for example, but not limited to, computer instructions, which, when executed, perform the method.

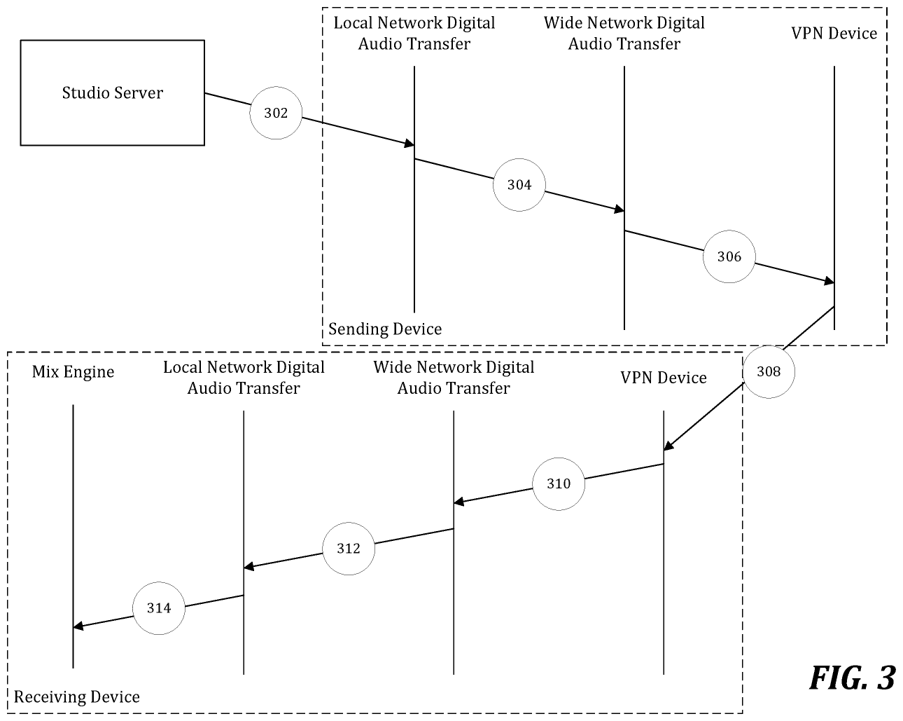

FIG. 3 is a data flow diagram showing the way data moves through a system (e.g., the platform 100) to effect delivery of communication data between devices (e.g., a first device 102a and a second device 102b) in the platform. In embodiments, the communication data may be audio communications from a director or supervisor to an audio engineer. For example, the communications may indicate issues with the audio, upcoming changes to be made to the broadcast feed, or any other information the director believes the audio engineer may find relevant to performing their job. In such cases, a sending device may be the first device 102a located at the first geographic location associated with the event venue, and the receiving device may be the second device 102b located at a second geographic location associated with the audio engineer. Additionally or alternatively, the communication data may be audio communications from the audio engineer to the director or supervisor. For example, the communications data may include am audio response from the audio engineer to the director or supervisor to confirm the instructions and/or to alert the director or supervisor to any audio issues. In such cases, the sending device may be the second device 102b, and the receiving device may be the first device 102a.

As shown at 302, the communications may initiate from a studio communications server associated with a sending device. In particular, the communication data may comprise data from a microphone connected to the studio communications server. The audio server may output data in a digital format suitable for transport within a local network, such as Dante.

At 304, the communications data may be converted to MADI format at the sending device. The MADI format may allow for additional audio processing and/or facilitate additional data conversion, as needed.

At 306, the communication data may be converted to another format at the sending device, for communication across a wide area network, such as the Internet (e.g., using Ravenna, SRT, or the like). This format may be useful to help overcome network irregularities (e.g., latency, jitter, etc.) inherent in communications over a long distance).

At 308 the communication data may be transmitted from the sending device to the receiving device. In embodiments, the data may be packetized, and may be transmitted using a secure communication network, such as a pre-established VPN that connects the sending device and the receiving device. The data may be transferred via a known protocol conducive to transport of audio data. The communication data may be received at the receiving device in the format for communication across the wide area network. In particular, the same Ravenna technology used to format the communication data for transfer at the sending device may be used at the receiving device for receiving the data in the same format.

At 310, the receiving device may convert the data to a format, such as MADI for local use. The format may allow for additional audio processing by the receiving device, and/or may be useful in aiding conversion to other formats.

At 312, the data may be converted to another format, such as Dante, by the receiving device. This other format may be useful in transmitting the communications data across a local network at the receiving device.

At 314, the receiving device may provide the communications data to a mix engine, communications server, and/or other device for playback of the communications data. In this way, the communications data may be relayed from a sending device to a receiving device substantially in real time. The receiving device need not be local to (e.g., collocated with) the sending device. Rather, the devices may be separated by an arbitrarily large distance, provided that both devices are connected to a wide area network, such as the internet.

### C. Method for Sending Audio Signals Between Devices

Consistent with embodiments of the present disclosure, a method for sending audio signals between devices may be performed by at least one of the aforementioned modules. The method may be embodied as, for example, but not limited to, computer instructions, which, when executed, perform the method.

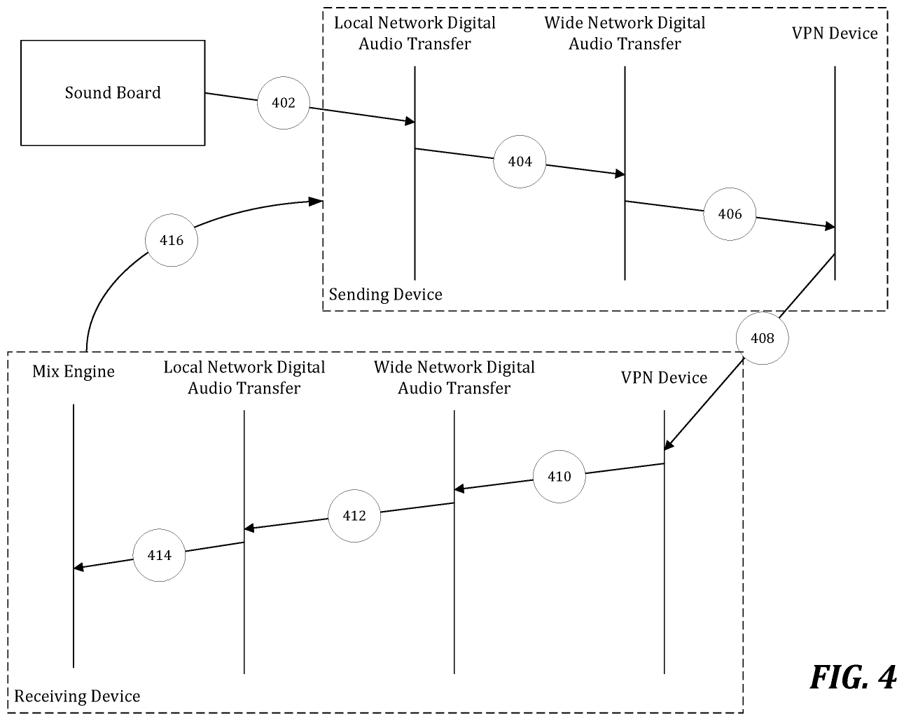

FIG. 4 is a data flow diagram showing the way data moves through a system (e.g., the platform 100) to effect delivery of audio signals between devices (e.g., a first device 102a and a second device 102b) in the platform 100. In embodiments, the audio signals may comprise audio signals produced and captured for broadcast of an event.

As shown at 402, the audio signals may originate from a soundboard at an event (e.g., a speaking engagement, concert, corporate event, festival, or the like) and be transmitted to a sending device. In other embodiments, the audio signals may be generated internally at the sending device (e.g., using a mix engine). The audio signals may comprise a plurality of channels to be mixed as part of the event, to be provided to a live audience and/or an audience of virtual attendees. In particular, the audio signals may comprise data from microphones, instrument pickups, prerecorded sources, and/or other devices connected to the soundboard. The soundboard may output data in a digital format suitable for transport within a local network, such as Dante.

At 404, the audio signals may be converted to MADI format at the sending device. The MADI format may allow for additional audio processing and/or facilitate additional data conversion, as needed.

At 406, the audio signals may be converted to another format at the sending device, for communication across a wide area network, such as the Internet (e.g., using Ravenna, SRT, or the like). This format may be useful to help overcome network irregularities (e.g., latency, jitter, etc.) inherent in communications over a long distance).

At 408 the audio signals may be transmitted from the sending device to the receiving device. In embodiments, the data may be packetized, and may be transmitted using a secure communication network, such as a pre-established VPN that connects the sending device and the receiving device. The data may be transferred via a known protocol conducive to transport of audio data. The communication data may be received at the receiving device in the format for communication across the wide area network. In particular, the same Ravenna technology used to format the audio signals for transfer at the sending device may be used at the receiving device for receiving the data in the same format.

At 410, the receiving device may convert the audio signals to a format, such as MADI for local use. The format may allow for additional audio processing by the receiving device, and/or may be useful in aiding conversion to other formats.

At 412, the data may be converted to another format, such as Dante, by the receiving device. This other format may be useful in transmitting the audio signals across a local network at the receiving device.

At 414, the receiving device may provide the audio signals to a mix engine and/or other device for mixing. In some embodiments, the receiving device may be operated by an audio engineer capable of providing a sound mix for the event.

In embodiments, the receiving device may transmit data back to the sending device at 416. In some embodiments, the data transmitted from the receiving device to the sending device may include one or more cues that cause the sending device to mix the audio signals in the same way the audio engineer mixes them at the receiving device. Additionally or alternatively, the data transmitted to the sending device may comprise the mixed audio produced at the receiving device. In this way, the receiving device may be used to remotely mix audio signals for an event at which the sending device is deployed. The receiving device need not be local to (e.g., collocated with) the first device. Accordingly, there is no need for the audio engineer to be located at the event venue (e.g., in an audio truck or sound booth). Rather, the devices may be separated by an arbitrarily large distance, provided that both devices are connected to a wide area network, such as the internet. In this way, the need for the audio engineer to travel to the event venue is eliminated.

### IV. Computing Device Arhitecture

Embodiments of the present disclosure provide a hardware and software platform operative as a distributed system of modules and computing elements.

Platform 100 may be embodied as, for example, but not be limited to, a website, a web application, a desktop application, a backend application, and a mobile application compatible with a computing device 500. The computing device 500 may comprise, but not be limited to, the following:

Mobile computing device, such as, but is not limited to, a laptop, a tablet, a smartphone, a drone, a wearable, an embedded device, a handheld device, an Arduino, an industrial device, or a remotely operable recording device;

A supercomputer, an exascale supercomputer, a mainframe, or a quantum computer;

A minicomputer, wherein the minicomputer computing device comprises, but is not limited to, an IBM AS400/iSeries/System I, A DEC VAX/PDP, an HP3000, a Honeywell-Bull DPS, a Texas Instruments TI-990, or a Wang Laboratories VS Series;

A microcomputer, wherein the microcomputer computing device comprises, but is not limited to, a server, wherein a server may be rack-mounted, a workstation, an industrial device, a raspberry pi, a desktop, or an embedded device;

Embodiments of the present disclosure may comprise a system having a central processing unit (CPU) 520, a bus 530, a memory unit 540, a power supply unit (PSU) 550, and one or more Input/Output (I/O) units. The CPU 520 coupled to the memory unit 540 and the plurality of I/O units 560 via the bus 530, all of which are powered by the PSU 550. It should be understood that, in some embodiments, each disclosed unit may actually be a plurality of such units for redundancy, high availability, and/or performance purposes. The combination of the presently disclosed units is configured to perform the stages of any method disclosed herein.

FIG. 5 is a block diagram of a system including computing device 500. Consistent with an embodiment of the disclosure, the aforementioned CPU 520, the bus 530, the memory unit 540, a PSU 550, and the plurality of I/O units 560 may be implemented in a computing device, such as computing device 500 of FIG. 5. Any suitable combination of hardware, software, or firmware may be used to implement the aforementioned units. For example, the CPU 520, the bus 530, and the memory unit 540 may be implemented with computing device 500 or any of other computing devices 500, in combination with computing device 500. The aforementioned system, device, and components are examples and other systems, devices, and components may comprise the aforementioned CPU 520, the bus 530, and the memory unit 540, consistent with embodiments of the disclosure.

At least one computing device 500 may be embodied as any of the computing elements illustrated in all of the attached figures, including [list the modules and methods]. A computing device 500 does not need to be electronic, nor even have a CPU 520, nor bus 530, nor memory unit 540. The definition of the computing device 500 to a person having ordinary skill in the art is “A device that computes, especially a programmable [usually] electronic machine that performs high-speed mathematical or logical operations or that assembles, stores, correlates, or otherwise processes information.” Any device which processes information qualifies as a computing device 500, especially if the processing is purposeful.

With reference to FIG. 5, a system consistent with an embodiment of the disclosure may include a computing device, such as computing device 500. In some configurations, the computing device 500 may include at least one clock module 510, at least one CPU 520, at least one bus 530, and at least one memory unit 540, at least one PSU 550, and at least one I/O 560 module, wherein I/O module may be comprised of, but not limited to a non-volatile storage sub-module 561, a communication sub-module 562, a sensors sub-module 563, and a peripherals sub-module 564.

In a system consistent with an embodiment of the disclosure, the computing device 500 may include the clock module 510, known to a person having ordinary skill in the art as a clock generator, which produces clock signals. Clock signals may oscillate between a high state and a low state at a controllable rate, and may be used to synchronize or coordinate actions of digital circuits. Most integrated circuits (ICs) of sufficient complexity use a clock signal in order to synchronize different parts of the circuit, cycling at a rate slower than the worst-case internal propagation delays. One well-known example of the aforementioned integrated circuit is the CPU 520, the central component of modern computers, which relies on a clock signal. The clock 510 can comprise a plurality of embodiments, such as, but not limited to, a single-phase clock which transmits all clock signals on effectively 1 wire, a two-phase clock which distributes clock signals on two wires, each with non-overlapping pulses, and a four-phase clock which distributes clock signals on 4 wires.

Many computing devices 500 may use a “clock multiplier” which multiplies a lower frequency external clock to the appropriate clock rate of the CPU 520. This allows the CPU 520 to operate at a much higher frequency than the rest of the computing device 500, which affords performance gains in situations where the CPU 520 does not need to wait on an external factor (like memory 540 or input/output 560). Some embodiments of the clock 510 may include dynamic frequency change, where the time between clock edges can vary widely from one edge to the next and back again.

In a system consistent with an embodiment of the disclosure, the computing device 500 may include the CPU 520 comprising at least one CPU Core 521. In other embodiments, the CPU 520 may include a plurality of identical CPU cores 521, such as, but not limited to, homogeneous multi-core systems. It is also possible for the plurality of CPU cores 521 to comprise different CPU cores 521, such as, but not limited to, heterogeneous multi-core systems, big.LITTLE systems and some AMD accelerated processing units (APU). The CPU 520 reads and executes program instructions which may be used across many application domains, for example, but not limited to, general purpose computing, embedded computing, network computing, digital signal processing (DSP), and graphics processing (GPU). The CPU 520 may run multiple instructions on separate CPU cores 521 simultaneously. The CPU 520 may be integrated into at least one of a single integrated circuit die, and multiple dies in a single chip package. The single integrated circuit die and/or the multiple dies in a single chip package may contain a plurality of other elements of the computing device 500, for example, but not limited to, the clock 510, the bus 530, the memory 540, and I/O 560.

The CPU 520 may contain cache 522 such as but not limited to a level 1 cache, a level 2 cache, a level 3 cache, or combinations thereof. The cache 522 may or may not be shared amongst a plurality of CPU cores 521. The cache 522 sharing may comprise at least one of message passing and inter-core communication methods used for the at least one CPU Core 521 to communicate with the cache 522. The inter-core communication methods may comprise, but not be limited to, bus, ring, two-dimensional mesh, and crossbar. The aforementioned CPU 520 may employ symmetric multiprocessing (SMP) design.

The one or more CPU cores 521 may comprise soft microprocessor cores on a single field programmable gate array (FPGA), such as semiconductor intellectual property cores (IP Core). The architectures of the one or more CPU cores 521 may be based on at least one of, but not limited to, Complex Instruction Set Computing (CISC), Zero Instruction Set Computing (ZISC), and Reduced Instruction Set Computing (RISC). At least one performance-enhancing method may be employed by one or more of the CPU cores 521, for example, but not limited to Instruction-level parallelism (ILP) such as, but not limited to, superscalar pipelining, and Thread-level parallelism (TLP).

Consistent with the embodiments of the present disclosure, the aforementioned computing device 500 may employ a communication system that transfers data between components inside the computing device 500, and/or the plurality of computing devices 500. The aforementioned communication system will be known to a person having ordinary skill in the art as a bus 530. The bus 530 may embody internal and/or external hardware and software components, for example, but not limited to a wire, an optical fiber, various communication protocols, and/or any physical arrangement that provides the same logical function as a parallel electrical bus. The bus 530 may comprise at least one of: a parallel bus, wherein the parallel bus carries data words in parallel on multiple wires; and a serial bus, wherein the serial bus carries data in bit-wise serial form. The bus 530 may embody a plurality of topologies, for example, but not limited to, a multidrop/electrical parallel topology, a daisy chain topology, and connected by switched hubs, such as a USB bus. The bus 530 may comprise a plurality of embodiments, for example, but not limited to:
Internal data bus (data bus) 531/Memory bus
Control bus 532
Address bus 533
System Management Bus (SMBus)
Front-Side-Bus (FSB)
External Bus Interface (EBI)
Local bus
Expansion bus
Lightning bus
Controller Area Network (CAN bus)
Camera Link
ExpressCard
Advanced Technology management Attachment (ATA), including embodiments and derivatives such as, but not limited to, Integrated Drive Electronics (IDE)/Enhanced IDE (EIDE), ATA Packet Interface (ATAPI), Ultra-Direct Memory Access (UDMA), Ultra ATA (UATA)/Parallel ATA (PATA)/Serial ATA (SATA), CompactFlash (CF) interface, Consumer Electronics ATA (CE-ATA)/Fiber Attached Technology Adapted (FATA), Advanced Host Controller Interface (AHCI), SATA Express (SATAe)/External SATA (eSATA), including the powered embodiment eSATAp/Mini-SATA (mSATA), and Next Generation Form Factor (NGFF)/M.2.
Small Computer System Interface (SCSI)/Serial Attached SCSI (SAS)
HyperTransport
InfiniBand
RapidIO
Mobile Industry Processor Interface (MIPI)
Coherent Processor Interface (CAPI)
Plug-n-play
1-Wire
Peripheral Component Interconnect (PCI), including embodiments such as but not limited to, Accelerated Graphics Port (AGP), Peripheral Component Interconnect extended (PCI-X), Peripheral Component Interconnect Express (PCI-e) (e.g., PCI Express Mini Card, PCI Express M.2 [Mini PCIe v2], PCI Express External Cabling [ePCIe], and PCI Express OCuLink [Optical Copper {Cu} Link]), Express Card, AdvancedTCA, AMC, Universal 10, Thunderbolt/Mini DisplayPort, Mobile PCIe (M-PCIe), U.2, and Non-Volatile Memory Express (NVMe)/Non-Volatile Memory Host Controller Interface Specification (NVMHCIS).
Industry Standard Architecture (ISA), including embodiments such as, but not limited to Extended ISA (EISA), PC/XT-bus/PC/AT-bus/PC/104 bus (e.g., PC/104-Plus, PCI/104-Express, PCI/104, and PCI-104), and Low Pin Count (LPC).
Music Instrument Digital Interface (MIDI)
Universal Serial Bus (USB), including embodiments such as, but not limited to, Media Transfer Protocol (MTP)/Mobile High-Definition Link (MHL), Device Firmware Upgrade (DFU), wireless USB, InterChip USB, IEEE 1394 Interface/Firewire, Thunderbolt, and extensible Host Controller Interface (xHCI).

Consistent with the embodiments of the present disclosure, the aforementioned computing device 500 may employ hardware integrated circuits that store information for immediate use in the computing device 500, known to persons having ordinary skill in the art as primary storage or memory 540. The memory 540 operates at high speed, distinguishing it from the non-volatile storage sub-module 561, which may be referred to as secondary or tertiary storage, which provides relatively slower-access to information but offers higher storage capacity. The data contained in memory 540, may be transferred to secondary storage via techniques such as, but not limited to, virtual memory and swap. The memory 540 may be associated with addressable semiconductor memory, such as integrated circuits consisting of silicon-based transistors, that may be used as primary storage or for other purposes in the computing device 500. The memory 540 may comprise a plurality of embodiments, such as, but not limited to volatile memory, non-volatile memory, and semi-volatile memory. It should be understood by a person having ordinary skill in the art that the following are non-limiting examples of the aforementioned memory:
Volatile memory, which requires power to maintain stored information, for example, but not limited to, Dynamic Random-Access Memory (DRAM) 541, Static Random-Access Memory (SRAM) 542, CPU Cache memory 525, Advanced Random-Access Memory (A-RAM), and other types of primary storage such as Random-Access Memory (RAM).
Non-volatile memory, which can retain stored information even after power is removed, for example, but not limited to, Read-Only Memory (ROM) 543, Programmable ROM (PROM) 544, Erasable PROM (EPROM) 545, Electrically Erasable PROM (EEPROM) 546 (e.g., flash memory and Electrically Alterable PROM [EAPROM]), Mask ROM (MROM), One Time Programmable (OTP) ROM/Write Once Read Many (WORM), Ferroelectric RAM (FeRAM), Parallel Random-Access Machine (PRAM), Split-Transfer Torque RAM (STT-RAM), Silicon Oxime Nitride Oxide Silicon (SONOS), Resistive RAM (RRAM), Nano RAM (NRAM), 3D XPoint, Domain-Wall Memory (DWM), and millipede memory.
Semi-volatile memory may have limited non-volatile duration after power is removed but may lose data after said duration has passed. Semi-volatile memory provides high performance, durability, and other valuable characteristics typically associated with volatile memory, while providing some benefits of true non-volatile memory. The semi-volatile memory may comprise volatile and non-volatile memory, and/or volatile memory with a battery to provide power after power is removed. The semi-volatile memory may comprise, but is not limited to, spin-transfer torque RAM (STT-RAM).

Consistent with the embodiments of the present disclosure, the aforementioned computing device 500 may employ a communication system between an information processing system, such as the computing device 500, and the outside world, for example, but not limited to, human, environment, and another computing device 500. The aforementioned communication system may be known to a person having ordinary skill in the art as an Input/Output (I/O) module 560. The I/O module 560 regulates a plurality of inputs and outputs with regard to the computing device 500, wherein the inputs are a plurality of signals and data received by the computing device 500, and the outputs are the plurality of signals and data sent from the computing device 500. The I/O module 560 interfaces with a plurality of hardware, such as, but not limited to, non-volatile storage 561, communication devices 562, sensors 563, and peripherals 564. The plurality of hardware is used by at least one of, but not limited to, humans, the environment, and another computing device 500 to communicate with the present computing device 500. The I/O module 560 may comprise a plurality of forms, for example, but not limited to channel I/O, port mapped I/O, asynchronous I/O, and Direct Memory Access (DMA).

Consistent with the embodiments of the present disclosure, the aforementioned computing device 500 may employ a non-volatile storage sub-module 561, which may be referred to by a person having ordinary skill in the art as one of secondary storage, external memory, tertiary storage, off-line storage, and auxiliary storage. The non-volatile storage sub-module 561 may not be accessed directly by the CPU 520 without using an intermediate area in the memory 540. The non-volatile storage sub-module 561 may not lose data when power is removed and may be orders of magnitude less costly than storage used in memory 540. Further, the non-volatile storage sub-module 561 may have a slower speed and higher latency than in other areas of the computing device 500. The non-volatile storage sub-module 561 may comprise a plurality of forms, such as, but not limited to, Direct Attached Storage (DAS), Network Attached Storage (NAS), Storage Area Network (SAN), nearline storage, Massive Array of Idle Disks (MAID), Redundant Array of Independent Disks (RAID), device mirroring, off-line storage, and robotic storage. The non-volatile storage sub-module (561) may comprise a plurality of embodiments, such as, but not limited to:
Optical storage, for example, but not limited to, Compact Disk (CD) (CD-ROM/CD-R/CD-RW), Digital Versatile Disk (DVD) (DVD-ROM/DVD-R/DVD+R/DVD-RW/DVD+RW/DVD+RW/DVD+R DL/DVD-RAM/HD-DVD), Blu-ray Disk (BD) (BD-ROM/BD-R/BD-RE/BD-R DL/BD-RE DL), and Ultra-Density Optical (UDO).
Semiconductor storage, for example, but not limited to, flash memory, such as, but not limited to, USB flash drive, Memory card, Subscriber Identity Module (SIM) card, Secure Digital (SD) card, Smart Card, CompactFlash (CF) card, Solid-State Drive (SSD) and memristor.
Magnetic storage such as, but not limited to, Hard Disk Drive (HDD), tape drive, carousel memory, and Card Random-Access Memory (CRAM).
Phase-change memory
Holographic data storage such as Holographic Versatile Disk (HVD).
Molecular Memory
Deoxyribonucleic Acid (DNA) digital data storage

Consistent with the embodiments of the present disclosure, the computing device 500 may employ a communication sub-module 562 as a subset of the I/O module 560, which may be referred to by a person having ordinary skill in the art as at least one of, but not limited to, a computer network, a data network, and a network. The network may allow computing devices 500 to exchange data using connections, which may also be known to a person having ordinary skill in the art as data links, which may include data links between network nodes. The nodes may comprise networked computer devices 500 that may be configured to originate, route, and/or terminate data. The nodes may be identified by network addresses and may include a plurality of hosts consistent with the embodiments of a computing device 500. Examples of computing devices that may include a communication sub-module 562 include, but are not limited to, personal computers, phones, servers, drones, and networking devices such as, but not limited to, hubs, switches, routers, modems, and firewalls.

Two nodes can be considered networked together when one computing device 500 can exchange information with the other computing device 500, regardless of any direct connection between the two computing devices 500. The communication sub-module 562 supports a plurality of applications and services, such as, but not limited to World Wide Web (WWW), digital video and audio, shared use of application and storage computing devices 500, printers/scanners/fax machines, email/online chat/instant messaging, remote control, distributed computing, etc. The network may comprise one or more transmission mediums, such as, but not limited to conductive wire, fiber optics, and wireless signals. The network may comprise one or more communications protocols to organize network traffic, wherein application-specific communications protocols may be layered, and may be known to a person having ordinary skill in the art as being improved for carrying a specific type of payload, when compared with other more general communications protocols. The plurality of communications protocols may comprise, but are not limited to, IEEE 802, ethernet, Wireless LAN (WLAN/Wi-Fi), Internet Protocol (IP) suite (e.g., TCP/IP, UDP, Internet Protocol version 4 [IPv4], and Internet Protocol version 6 [IPV6]), Synchronous Optical Networking (SONET)/Synchronous Digital Hierarchy (SDH), Asynchronous Transfer Mode (ATM), and cellular standards (e.g., Global System for Mobile Communications [GSM], General Packet Radio Service [GPRS], Code-Division Multiple Access [CDMA], Integrated Digital Enhanced Network [IDEN], Long Term Evolution [LTE], LTE-Advanced [LTE-A], and fifth generation [5G] communication protocols).

The communication sub-module 562 may comprise a plurality of size, topology, traffic control mechanisms and organizational intent policies. The communication sub-module 562 may comprise a plurality of embodiments, such as, but not limited to:
Wired communications, such as, but not limited to, coaxial cable, phone lines, twisted pair cables (ethernet), and InfiniBand.
Wireless communications, such as, but not limited to, communications satellites, cellular systems, radio frequency/spread spectrum technologies, IEEE 802.11 Wi-Fi, Bluetooth, NFC, free-space optical communications, terrestrial microwave, and Infrared (IR) communications. Wherein cellular systems embody technologies such as, but not limited to, 3G,4G (such as WiMAX and LTE), and 5G (short and long wavelength).
Parallel communications, such as, but not limited to, LPT ports.
Serial communications, such as, but not limited to, RS-232 and USB.
Fiber Optic communications, such as, but not limited to, Single-mode optical fiber (SMF) and Multi-mode optical fiber (MMF).
Power Line communications

The aforementioned network may comprise a plurality of layouts, such as, but not limited to, bus networks such as Ethernet, star networks such as Wi-Fi, ring networks, mesh networks, fully connected networks, and tree networks. The network can be characterized by its physical capacity or its organizational purpose. Use of the network, including user authorization and access rights, may differ according to the layout of the network. The characterization may include, but is not limited to a nanoscale network, a Personal Area Network (PAN), a Local Area Network (LAN), a Home Area Network (HAN), a Storage Area Network (SAN), a Campus Area Network (CAN), a backbone network, a Metropolitan Area Network (MAN), a Wide Area Network (WAN), an enterprise private network, a Virtual Private Network (VPN), and a Global Area Network (GAN).

Consistent with the embodiments of the present disclosure, the aforementioned computing device 500 may employ a sensors sub-module 563 as a subset of the I/O 560. The sensors sub-module 563 comprises at least one of the device, module, or subsystem whose purpose is to detect events or changes in its environment and send the information to the computing device 500. Sensors may be sensitive to the property they are configured to measure, may not be sensitive to any property not measured but be encountered in its application, and may not significantly influence the measured property. The sensors sub-module 563 may comprise a plurality of digital devices and analog devices, wherein if an analog device is used, an Analog to Digital (A-to-D) converter must be employed to interface the said device with the computing device 500. The sensors may be subject to a plurality of deviations that limit sensor accuracy. The sensors sub-module 563 may comprise a plurality of embodiments, such as, but not limited to, chemical sensors, automotive sensors, acoustic/sound/vibration sensors, electric current/electric potential/magnetic/radio sensors, environmental/weather/moisture/humidity sensors, flow/fluid velocity sensors, ionizing radiation/particle sensors, navigation sensors, position/angle/displacement/distance/speed/acceleration sensors, imaging/optical/light sensors, pressure sensors, force/density/level sensors, thermal/temperature sensors, and proximity/presence sensors. It should be understood by a person having ordinary skill in the art that the ensuing are non-limiting examples of the aforementioned sensors:
Chemical sensors, such as, but not limited to, breathalyzer, carbon dioxide sensor, carbon monoxide/smoke detector, catalytic bead sensor, chemical field-effect transistor, chemiresistor, electrochemical gas sensor, electronic nose, electrolyte-insulator-semiconductor sensor, energy-dispersive X-ray spectroscopy, fluorescent chloride sensors, holographic sensor, hydrocarbon dew point analyzer, hydrogen sensor, hydrogen sulfide sensor, infrared point sensor, ion-selective electrode, nondispersive infrared sensor, microwave chemistry sensor, nitrogen oxide sensor, olfactometer, optode, oxygen sensor, ozone monitor, pellistor, pH glass electrode, potentiometric sensor, redox electrode, zinc oxide nanorod sensor, and biosensors (such as nanosensors).
Automotive sensors, such as, but not limited to, air flow meter/mass airflow sensor, air-fuel ratio meter, AFR sensor, blind spot monitor, engine coolant/exhaust gas/cylinder head/transmission fluid temperature sensor, hall effect sensor, wheel/automatic transmission/turbine/vehicle speed sensor, airbag sensors, brake fluid/engine crankcase/fuel/oil/tire pressure sensor, camshaft/crankshaft/throttle position sensor, fuel/oil level sensor, knock sensor, light sensor, MAP sensor, oxygen sensor (o2), parking sensor, radar sensor, torque sensor, variable reluctance sensor, and water-in-fuel sensor.
Acoustic, sound and vibration sensors, such as, but not limited to, microphone, lace sensors such as a guitar pickup, seismometer, sound locator, geophone, and hydrophone.
Electric current, electric potential, magnetic, and radio sensors, such as, but not limited to, current sensor, Daly detector, electroscope, electron multiplier, faraday cup, galvanometer, hall effect sensor, hall probe, magnetic anomaly detector, magnetometer, magnetoresistance, MEMS magnetic field sensor, metal detector, planar hall sensor, radio direction finder, and voltage detector.
Environmental, weather, moisture, and humidity sensors, such as, but not limited to, actinometer, air pollution sensor, moisture alarm, ceilometer, dew warning, electrochemical gas sensor, fish counter, frequency domain sensor, gas detector, hook gauge evaporimeter, humistor, hygrometer, leaf sensor, lysimeter, pyranometer, pyrgeometer, psychrometer, rain gauge, rain sensor, seismometers, SNOTEL, snow gauge, soil moisture sensor, stream gauge, and tide gauge.
Flow and fluid velocity sensors, such as, but not limited to, air flow meter, anemometer, flow sensor, gas meter, mass flow sensor, and water meter.
Ionizing radiation and particle sensors, such as, but not limited to, cloud chamber, Geiger counter, Geiger-Muller tube, ionization chamber, neutron detection, proportional counter, scintillation counter, semiconductor detector, and thermoluminescent dosimeter.
Navigation sensors, such as, but not limited to, airspeed indicator, altimeter, attitude indicator, depth gauge, fluxgate compass, gyroscope, inertial navigation system, inertial reference unit, magnetic compass, MHD sensor, ring laser gyroscope, turn coordinator, variometer, vibrating structure gyroscope, and yaw rate sensor.
Position, angle, displacement, distance, speed, and acceleration sensors, such as but not limited to, accelerometer, displacement sensor, flex sensor, free-fall sensor, gravimeter, impact sensor, laser rangefinder, LIDAR, odometer, photoelectric sensor, position sensor such as, but not limited to, GPS or Glonass, angular rate sensor, shock detector, ultrasonic sensor, tilt sensor, tachometer, ultra-wideband radar, variable reluctance sensor, and velocity receiver.
Imaging, optical and light sensors, such as, but not limited to, CMOS sensor, colorimeter, contact image sensor, electro-optical sensor, infra-red sensor, kinetic inductance detector, LED configured as a light sensor, light-addressable potentiometric sensor, Nichols radiometer, fiber-optic sensors, optical position sensor, thermopile laser sensor, photodetector, photodiode, photomultiplier tubes, phototransistor, photoelectric sensor, photoionization detector, photomultiplier, photoresistor, photoswitch, phototube, scintillometer, Shack-Hartmann, single-photon avalanche diode, superconducting nanowire single-photon detector, transition edge sensor, visible light photon counter, and wavefront sensor.
Pressure sensors, such as, but not limited to, barograph, barometer, boost gauge, bourdon gauge, hot filament ionization gauge, ionization gauge, McLeod gauge, Oscillating U-tube, permanent downhole gauge, piezometer, Pirani gauge, pressure sensor, pressure gauge, tactile sensor, and time pressure gauge.
Force, Density, and Level sensors, such as, but not limited to, bhangmeter, hydrometer, force gauge or force sensor, level sensor, load cell, magnetic level or nuclear density sensor or strain gauge, piezocapacitive pressure sensor, piezoelectric sensor, torque sensor, and viscometer.
Thermal and temperature sensors, such as, but not limited to, bolometer, bimetallic strip, calorimeter, exhaust gas temperature gauge, flame detection/pyrometer, Gardon gauge, Golay cell, heat flux sensor, microbolometer, microwave radiometer, net radiometer, infrared/quartz/resistance thermometer, silicon bandgap temperature sensor, thermistor, and thermocouple.
Proximity and presence sensors, such as, but not limited to, alarm sensor, doppler radar, motion detector, occupancy sensor, proximity sensor, passive infrared sensor, reed switch, stud finder, triangulation sensor, touch switch, and wired glove.

Consistent with the embodiments of the present disclosure, the aforementioned computing device 500 may employ a peripherals sub-module 564 as a subset of the I/O 560. The peripheral sub-module 564 comprises ancillary devices used to put information into and get information out of the computing device 500. There are 3 categories of devices comprising the peripheral sub-module 564, which exist based on their relationship with the computing device 500, input devices, output devices, and input/output devices. Input devices send at least one of data and instructions to the computing device 500. Input devices can be categorized based on, but not limited to:
Modality of input, such as, but not limited to, mechanical motion, audio, visual, and tactile.
Whether the input is discrete, such as but not limited to, pressing a key, or continuous such as, but not limited to the position of a mouse.
The number of degrees of freedom involved, such as, but not limited to, two-dimensional mice and three-dimensional mice used for Computer-Aided Design (CAD) applications.

Output devices provide output from the computing device 500. Output devices convert electronically generated information into a form that can be presented to humans. Input/output devices perform that perform both input and output functions. It should be understood by a person having ordinary skill in the art that the ensuing are non-limiting embodiments of the aforementioned peripheral sub-module 564:
Input Devices
   Human Interface Devices (HID), such as, but not limited to, pointing device (e.g., mouse, touchpad, joystick, touchscreen, game controller/gamepad, remote, light pen, light gun, infrared remote, jog dial, shuttle, and knob), keyboard, graphics tablet, digital pen, gesture recognition devices, magnetic ink character recognition, Sip-and-Puff (SNP) device, and Language Acquisition Device (LAD).
   High degree of freedom devices, that require up to six degrees of freedom such as, but not limited to, camera gimbals, Cave Automatic Virtual Environment (CAVE), and virtual reality systems.
   Video Input devices are used to digitize images or video from the outside world into the computing device 500. The information can be stored in a multitude of formats depending on the user's requirement. Examples of types of video input devices include, but are not limited to, digital camera, digital camcorder, portable media player, webcam, Microsoft Kinect, image scanner, fingerprint scanner, barcode reader, 3D scanner, laser rangefinder, eye gaze tracker, computed tomography, magnetic resonance imaging, positron emission tomography, medical ultrasonography, TV tuner, and iris scanner.
   Audio input devices are used to capture sound. In some cases, an audio output device can be used as an input device to capture produced sound. Audio input devices allow a user to send audio signals to the computing device 500 for at least one of processing, recording, and carrying out commands. Devices such as microphones allow users to speak to the computer to record a voice message or navigate software. Aside from recording, audio input devices are also used with speech recognition software. Examples of types of audio input devices include, but not limited to microphone, Musical Instrumental Digital Interface (MIDI) devices such as, but not limited to a keyboard, and headset.
   Data AcQuisition (DAQ) devices convert at least one of analog signals and physical parameters to digital values for processing by the computing device 500. Examples of DAQ devices may include, but not limited to, Analog to Digital Converter (ADC), data logger, signal conditioning circuitry, multiplexer, and Time to Digital Converter (TDC).
Output Devices may further comprise, but not be limited to:
   Display devices may convert electrical information into visual form, such as, but not limited to, monitor, TV, projector, and Computer Output Microfilm (COM). Display devices can use a plurality of underlying technologies, such as, but not limited to, Cathode-Ray Tube (CRT), Thin-Film Transistor (TFT), Liquid Crystal Display (LCD), Organic Light-Emitting Diode (OLED), MicroLED, E Ink Display (ePaper) and Refreshable Braille Display (Braille Terminal).
   Printers, such as, but not limited to, inkjet printers, laser printers, 3D printers, solid ink printers, and plotters.
   Audio and Video (AV) devices, such as, but not limited to, speakers, headphones, amplifiers, and lights, which include lamps, strobes, DJ lighting, stage lighting, architectural lighting, special effect lighting, and lasers.
   Other devices such as Digital to Analog Converter (DAC)
Input/Output Devices may further comprise, but not be limited to, touchscreens, networking devices (e.g., devices disclosed in network sub-module 562), data storage devices (non-volatile storage 561), facsimile (FAX), and graphics/sound cards.

All rights, including copyrights in the code included herein, are vested in and the property of the Applicant. The Applicant retains and reserves all rights in the code included herein, and grants permission to reproduce the material only in connection with the reproduction of the granted patent and for no other purpose.

### V. Claims

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as examples for embodiments of the disclosure.

Insofar as the description above and the accompanying drawing disclose any additional subject matter that is not within the scope of the claims below, the disclosures are not dedicated to the public and the right to file one or more applications to claims such additional disclosures is reserved.

The following is claimed:

1. A method, comprising:
synchronizing timing of a first computing device at a first geographic location and a second computing device at a second geographic location;
receiving, at the first computing device, content data, wherein the content data comprises a plurality of content feeds;
transmitting the content data from the first computing device to the second computing device in real time;
receiving, from the second computing device, a cue comprising:
an indication of a subset of the content data, the subset of the content data indicating one or more content feeds to be included in a broadcast feed, and
a time at which the broadcast feed is to begin including the subset of the content data;
based on the received cue, selecting the indicated subset of the content data for inclusion in a broadcast feed at the indicated time; and
transmitting the broadcast feed to one or more content consumers.

2. The method of claim 1, wherein synchronizing the timing of the first computing device at the first geographic location and the second computing device at the second geographic location comprises:
connecting the first computing device to a first Global Positioning System (GPS) receiver configured to receive GPS communications from a first GPS satellite;
connecting the second computing device to a second Global Positioning System (GPS) receiver configured to receive GPS communications from a second GPS satellite; and
wherein the first GPS satellite and the second GPS satellite each transmit a synchronized clock time with the GPS communications, and wherein the first computing device and the second computing device use the synchronized clock time as a grandmaster clock.

3. The method of claim 2, wherein receiving the content data comprises:
receiving the plurality of content feeds via an input interface;
converting the plurality of content feeds to a first format for transmission within a local network; and
transmitting the content feeds in the first format to the first computing device via the local network.

4. The method of claim 3, wherein transmitting the content data from the first computing device to the second computing device in real time comprises:
converting the content feeds from the first format to a second format for transmission across a wide area network; and
transmitting the content feeds in the second format from the first computing device to the second computing device in real time via the wide area network.

5. The method of claim 4, further comprising:
receiving, at the first computing device, a first communications stream from a studio communications server, wherein the first communications stream comprises one or more instructions for an audio engineer working at the second geographic location;
converting the first communications stream to the second format;
transmitting the converted first communications stream to the second computing device via the wide area network, such that the first communications stream can be decoded at the second computing device; and
receiving, from the second computing device, a second communications stream comprising communications from the audio engineer.

6. The method of claim 1, further comprising:
receiving, from the second computing device and at the first computing device, a feed comprising content data for inclusion in the broadcast feed.

7. The method of claim 1, wherein the first computing device comprises a portable computing device configured for use at an event space, and wherein the second computing device is disposed remote from the performance venue.

8. The method of claim 1, wherein the content data included in the broadcast feed remains unchanged until a cue indicating a change to the broadcast feed is received.

9. The method of claim 1, wherein synchronizing the timing of the first computing device at the first geographic location and the second computing device at the second geographic location comprises using one or more of Network time protocol or Precision Time Protocol to synchronize the timing of the first computing device and the second computing device.

10. A system comprising:
at least one device including a hardware processor;
the system being configured to perform operations comprising:
synchronizing timing of a first computing device at a first geographic location and a second computing device at a second geographic location;
receiving, at the first computing device, content data, wherein the content data comprises a plurality of content feeds;
transmitting the content data from the first computing device to the second computing device in real time;
receiving, from the second computing device, a cue comprising:
an indication of a subset of the content data, the subset of the content data indicating one or more content feeds to be included in a broadcast feed, and
a time at which the broadcast feed is to begin including the subset of the content data;
based on the received cue, selecting the indicated subset of the content data for inclusion in a broadcast feed at the indicated time; and
transmitting the broadcast feed to one or more content consumers.

11. The system of claim 10, wherein synchronizing the timing of the first computing device at the first geographic location and the second computing device at the second geographic location comprises:
connecting the first computing device to a first Global Positioning System (GPS) receiver configured to receive GPS communications from a first GPS satellite;
connecting the second computing device to a second Global Positioning System (GPS) receiver configured to receive GPS communications from a second GPS satellite; and
wherein the first GPS satellite and the second GPS satellite each transmit a synchronized clock time with the GPS communications, and wherein the first computing device and the second computing device use the synchronized clock time as a grandmaster clock.

12. The system of claim 11, wherein receiving the content data comprises:
receiving the plurality of content feeds via an input interface;
converting the plurality of content feeds to a first format for transmission within a local network; and
transmitting the content feeds in the first format to the first computing device via the local network.

13. The system of claim 12, wherein transmitting the content data from the first computing device to the second computing device in real time comprises:
converting the content feeds from the first format to a second format for transmission across a wide area network; and
transmitting the content feeds in the second format from the first computing device to the second computing device in real time via the wide area network.

14. The system of claim 13, the operations further comprising:
receiving, at the first computing device, a first communications stream from a studio communications server, wherein the first communications stream comprises one or more instructions for an audio engineer working at the second geographic location;
converting the first communications stream to the second format;
transmitting the converted first communications stream to the second computing device via the wide area network, such that the first communications stream can be decoded at the second computing device; and
receiving, from the second computing device, a second communications stream comprising communications from the audio engineer.

15. The system of claim 10, the operations further comprising:
receiving, from the second computing device and at the first computing device, a feed comprising content data for inclusion in the broadcast feed.

16. The system of claim 10, wherein the first computing device comprises a portable computing device configured for use at an event space, and wherein the second computing device is disposed remote from the performance venue.

17. The system of claim 10, wherein the content data included in the broadcast feed remains unchanged until a cue indicating a change to the broadcast feed is received.

18. The system of claim 10, wherein synchronizing the timing of the first computing device at the first geographic location and the second computing device at the second geographic location comprises using one or more of Network time protocol or Precision Time Protocol to synchronize the timing of the first computing device and the second computing device.

19. One or more non-transitory computer readable media comprising instructions which, when executed by one or more hardware processors, causes performance of operations comprising:
synchronizing timing of a first computing device at a first geographic location and a second computing device at a second geographic location;
receiving, at the first computing device, content data, wherein the content data comprises a plurality of content feeds;
transmitting the content data from the first computing device to the second computing device in real time;
receiving, from the second computing device, a cue comprising:
an indication of a subset of the content data, the subset of the content data indicating one or more content feeds to be included in a broadcast feed, and
a time at which the broadcast feed is to begin including the subset of the content data;
based on the received cue, selecting the indicated subset of the content data for inclusion in a broadcast feed at the indicated time; and
transmitting the broadcast feed to one or more content consumers.

20. The one or more computer-readable media of claim 19, wherein receiving the content data comprises:
receiving the plurality of content feeds via one or more input interfaces,
converting the plurality of content feeds to a first format for transmission within a local network, and
transmitting the content feeds in the first format to the first computing device via the local network; and
wherein transmitting the content data from the first computing device to the second computing device in real time comprises:
converting the content feeds from the first format to a second format for transmission across a wide area network, and
transmitting the content feeds in the second format from the first computing device to the second computing device in real time via the wide area network.
